(19) United States
(12) Patent Application Publication
(10) Pub. No.: US 2007/0076082 A1
(43) Pub. Date: Apr. 5, 2007

(54) Methods and apparatuses for measuring print area using hand-held printer

(75) Inventor: Brian Dale Cook, Nicholasville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/241,094

(22) Filed: Sep. 30, 2005

(51) Int. Cl. B41J 3/36

(52) U.S. Cl. 347/109

(57) ABSTRACT

The size of a print area may be determined using a hand-held printer including an internal tracking device, such as an optical mouse device. Based on the size of the print area, and one or more user settings, an image to be printed on the print surface by the hand-held printer may be scaled and/or repositioned. The hand-held printer may print the image to a desired size while centering the image or otherwise repositioning it, scaling it to fit within user-defined margins or areas, and the like.

### FIELD OF THE INVENTION

The present invention relates generally to handheld printers, and more particularly, to systems, methods and apparatuses for measuring the allowable print area to scale and/or position an image to be printed using a hand-held printer.

### BACKGROUND OF THE INVENTION

Portable computer printers are well known in the prior art and include dot-matrix printers, piezo-electric ink jet printers, laser printers and thermal ink jet printers. When using handheld printers the printing surface is not fed through printer, but rather the handheld printer is placed on a printing surface.

On many handheld printers, printing is started and stopped through the depression of a “print” button. The printer head is first applied to the desired printing surface where the user wants printing to commence. The handheld printer is generally aligned with the printing surface in a fashion so that the image may be linearly printed across the surface. The user next presses the button to initiate the printer head to begin printing the desired image onto the printing surface. This process continues for as long as the user depresses the print button or until an image to be printed is complete.

Unlike a standard printer that prints on standard size sheets of paper, the size of an image printed with a hand-held printer is determined by the size of the to-be-printed image. Because the printing device does not know in advance the size of the surface on which the printing will occur, the printed image may be too long, too short, too tall, or just not tall enough for the target print area. In addition, positioning the image on the media may be difficult without measuring and providing layout marks before printing begins.

Therefore, a need exists for methods and apparatuses that identifies the size of a target print area and scales and/or positions an image accordingly.

### BRIEF SUMMARY OF THE INVENTION

Methods and apparatuses of the present invention determine the size of a print area using a hand-held printer including an internal tracking device, such as an optical mouse device. Based on this information, an image to be printed on the print surface by the hand-held printer may be scaled and/or repositioned. The hand-held printer may also print the image to a desired size while centering the image or otherwise repositioning it, scaling it to fit within user-defined margins or areas, and the like.

According to an embodiment of the invention, there is disclosed a method of printing a resized image using a hand-held printer. The method includes identifying the location of a first edge of a printing area, identifying the location of a second edge of the printing area, where the second edge is opposite the first edge, and determining the distance between the first edge and the second edge. The method further includes resizing an original image to create a resized image, where resizing the original image is based at least in part on the distance between the first edge and the second edge. The method also includes printing the resized image on the printing surface using the hand-held printer.

According to an aspect of the invention, the method may also include comparing the distance between the first edge and the second edge to the original image to determine the size of the resized image. According to another aspect of the invention, resizing the original image may include scaling or stretching the original image. According to yet another aspect of the invention, the method may include receiving at least one user setting associated with the resizing of the original image. The at least one user setting may identify a desired position of the resized image on the printing surface. Furthermore, printing the resized image may include printing the resized image on the printing surface at the desired position identified by the at least one user setting.

According to yet another aspect of the invention, the method includes identifying the location of at least one margin associated with the printing area, and resizing the original image further includes resizing the original image based at least in part on the location of the at least one margin. According to another aspect, the degree of resizing of the original image is based at least in part on the distance between the first edge and the second edge. The method may also include identifying the location of a third edge of the printing area, and the location of a fourth edge of the printing area, where the fourth edge is opposite the third edge. The method may further include determining the distance between the third edge and the fourth edge, and resizing the original image may be further based at least in part on the distance between the third edge and the fourth edge.

According to another embodiment of the invention, there is disclosed a method of positioning an image printed by a hand-held printer. The method includes identifying the location of a first edge of a printing area, identifying the location of a second edge of the printing area, where the second edge is opposite the first edge, and determining the distance between the first edge and the second edge. The method also includes receiving at least one user setting, where the at least one user setting identifies a desired image position, and using the hand-held printer to printing an image, where the image is printed on the printed surface at a location based at least in part on the desired image position and the distance between the first edge and the second edge.

According to an aspect of the invention, the method may include resizing the image, prior to printing the image, where resizing the image is based at least in part on the distance between the first edge and the second edge. Resizing the original image may include scaling or stretching the original image. According to another aspect of the invention, receiving at least one user setting may include receiving at least one user setting identifying whether the original image will be resized by scaling or stretching. The at least one user setting may also identify a desired image position relative to the first edge and the second edge of the printing area.

According to yet another aspect of the invention, the method may include identifying the location of a third edge of the printing area and the location of a fourth edge of the printing area, where the fourth edge is opposite the third edge. The method may also include determining the distance between the third edge and the fourth edge, where the image may be printed on the printed surface at a location based at least in part on the distance between the fourth edge and the third edge. According to another aspect of the invention, the method may include comprising resizing the image, prior to printing the image, where resizing the image is based at least in part on the distance between the third edge and the fourth edge. According to yet another aspect of the invention, identifying the location of the first edge of a printing area may be based at least in part on a tracking device of the hand-held printer. Furthermore, identifying the location of the second edge of a printing area may include identifying a position of the hand-held printer respective to the location of the first edge.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a perspective view of a hand-held printer 100, according to an illustrative embodiment of the present invention.

FIG. 2 shows a top view of a hand-held printer, according to an illustrative embodiment of the present invention.

FIG. 3 shows the use of a hand-held printer to identify two edges of a printing area, according to an illustrative embodiment of the present invention.

FIG. 4 shows the use of a hand-held printer to identify four edges of a printing area, according to an illustrative embodiment of the present invention.

FIG. 5 shows a printing area including an original image, and scaled and stretched versions of the same, according to an illustrative example of the present invention.

FIG. 6 shows a printing area including an original image and a repositioned version of the same, according to an illustrative example of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

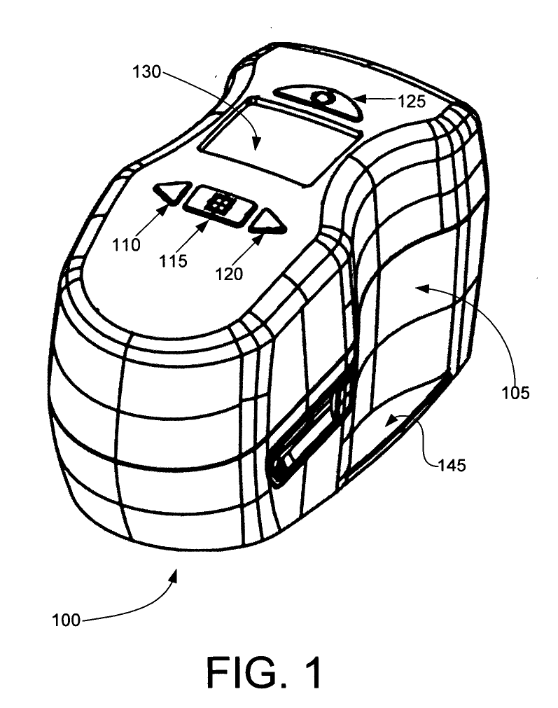

FIG. 1 shows a perspective view of a hand-held printer 100, according to an embodiment of the present invention. The hand-held printer 100 generally includes a housing 105 for enclosing printer components, a display screen 130, such as an LCD screen, and one or more buttons 110, 115, 120, 125 for controlling the operation of hand-held printer 100. To print the hand-held printer 100 also includes a printer head (not illustrated) that emits a marking substance, such as ink, onto a printing surface. Also included within the hand-held printer 100 is at least one internal tracking device (not illustrated) to identify the location of the hand-held printer 100, as is known in the art. The internal tracking device may include an optical tracking device, or one or more rolling elements, to identify the location and orientation of the hand-held printer 100.

According to one aspect of the invention, the one or more buttons 110, 115, 120, 125 are operative to enable a user to select and control one or more operations or functions of the hand-held printer 100. For instance, the buttons 110, 115, 120, 125 permit a user to select an image for printing, to print using the hand-held printer 100, and to measure the print area of a printing surface, such as a piece of paper, which receives a printed image. According to one aspect of the invention, the one or more buttons 110, 115, 120, 125 may represent ‘soft’ buttons whose associated functions are displayed on the display 130. According to another aspect of the invention, the one or more buttons 110, 115, 120, 125 may be used to highlight and select functions displayed on the display 130. Although illustrated on a top side of the hand-held printer 100, it will be appreciated that the one or more buttons 110, 115, 120, 125 may be positioned anywhere on the housing 105 of the hand-held printer 100.

A user may initiate printing through the issuance of a command to the handheld printer 110. Such a command may come from the pressing of one or more buttons 110, 115, 120, 125, which may trigger the print head to begin printing an image. In alternate embodiments, print commands may come by way of voice commands or optical impulses. The handheld printer 100 may receive image data for printing from a number of sources. For instance, the handheld printer 100 may receive image data from a computer via a cable or wireless connection, such as via a USB cable or via Bluetooth. The image data will be stored within a memory in the hand-held printer 100 for use in printing. According to another illustrative embodiment, a memory card containing image data, for instance, in an image file, may be inserted in to the handheld printer 100 and act as the local memory of the printer.

As illustrated in FIG. 1, the handheld printer 100 includes a display screen 130. According to an aspect of the invention, the display screen 130 may be operable to display a representation of the amount of the currently printing image that has been printed at any given point in time. According to another aspect of the invention, the user can view the image to be printed on the LCD screen, or may view a file name associated with the image. The display screen 130 may also alert the user that an image has been completely printed by the hand-held printer 100.

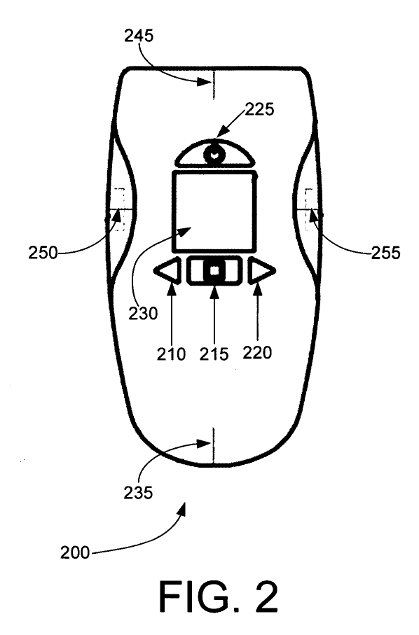

FIG. 2 shows a top view of a handheld printer 200, according to an illustrative embodiment of the present invention. According to an aspect of the invention, the hand-held printer 200 includes a display 230 and one or more buttons 210, 215, 220, 225 that operate in a similar manner, respectively, as the display 130 and one or more buttons 110, 115, 120, 125 described above with respect to FIG. 1. Although not shown in FIG. 2, the hand-held printer 200 also includes a printer head that emits a marking substance, such as ink, onto a printing surface to print an image, and at least one internal tracking device (not illustrated) to identify the location of the hand-held printer 200, as is known in the art.

As shown in FIG. 2, the hand-held printer 200 also includes left and right alignment marks 250, 255, and upper and lower alignment marks 245, 235. The left and right alignment marks 250, 255 each include a horizontally disposed line, while the upper and lower alignment marks 245, 235 each include a vertically disposed line. According to one aspect of the invention, each of the four alignment marks 250, 255, 245, 235 may be disposed on a flat surface extending from one or more indentations in the housing of the hand-held printer 200. For instance, the left and right alignment marks 250, 255 may be disposed on flat surfaces on each side of the hand-held printer 200 similar to the flat surface 145 shown on the hand-held printer 100 of FIG. 1. According to an aspect of the invention, the flat surface on which the alignment marks are printed may be transparent. According to another aspect of the invention, one or more of the alignment marks 250, 255, 245, 235 may be disposed on the top of the hand-held printer.

According to an embodiment of the invention, the hand-held printer 200 may be placed in a measurement mode and the alignment marks 250, 255, 245, 235 may be used to identify the boundary of a printing area. Specifically, the hand-held printer 200 may be aligned with a first edge of a printing area, which is identified by one or more user commands as a first edge, and the printer may be dragged to an opposing second edge. The user can input another command, e.g., by depressing one or more buttons 210, 215, 220, 225 to identify that the hand-held printer is positioned on the second edge. The hand-held printer 200 identifies and stores the location of the second edge, as identified with reference to the first edge, which may be determined by the printer 200 using its at least one internal tracking device. For instance, if the first edge is stored by the hand-held printer as existing at the coordinates 0,0, the second edge may be identified as located at coordinates X,Y. This process may be used to identify the right and left edges of a printing area, and may be repeated to identify the upper and lower edges of the printing area. Additionally, the upper and/or lower edges are stored relative to the left and/or right edges, or vice versa, so that the hand-held printer can identify the entire area of a print surface.

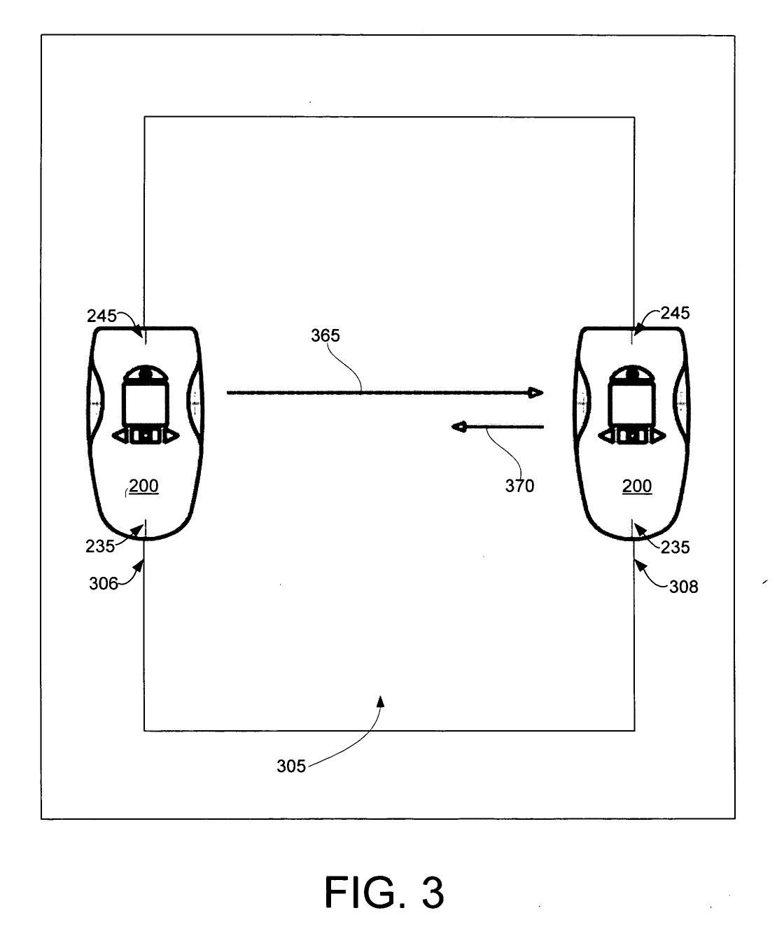

FIG. 3 shows the use of a hand-held printer 200 to identify two edges of a printing area 305, such as a piece of paper, according to an illustrative embodiment of the present invention. As shown, the user aligns the upper and lower alignment marks 245, 235 of the printer 200 with the left hand side 306 of the printing area 305. The user may then depress one or more buttons on the printer to alert the printer 200 that it is in position directly over the left edge of the printing area 305. According to one aspect of the invention, the printer 200 may utilize the display 230 to instruct the user to position the printer 200 on the left edge 306 of the printing area 305, and to depress one or more buttons to identify that the printer 200 is aligned with the edge. According to one aspect of the invention, the printer 200 can store the position in memory and use the position as a starting point for identifying the boundaries of the printing area. However, it will be appreciated that the coordinates of a first edge may not be required to be stored where the printer 200 resets the coordinates to 0,0 after the printer's 200 alignment with the first edge.

Next, the user can drag the hand-held printer 200 across the printing area 305 to the opposing edge 308 of the printing area 305, illustrated as the right edge in FIG. 3. The display may instruct the user to take such an action following the identification of the opposing edge of the area 305. After the user aligns the printer with the right side of the printing area 305 using the upper and lower alignment marks 245, 235, the user may depress one or more buttons on the printer to alert the printer 200 that it is in position directly over the right edge of the printing area 305. The printer 200 will then identify the location of the printer 200 using its at least one internal tracking device, and will store the position of the right edge, for instance, by storing the coordinates of the right edge.

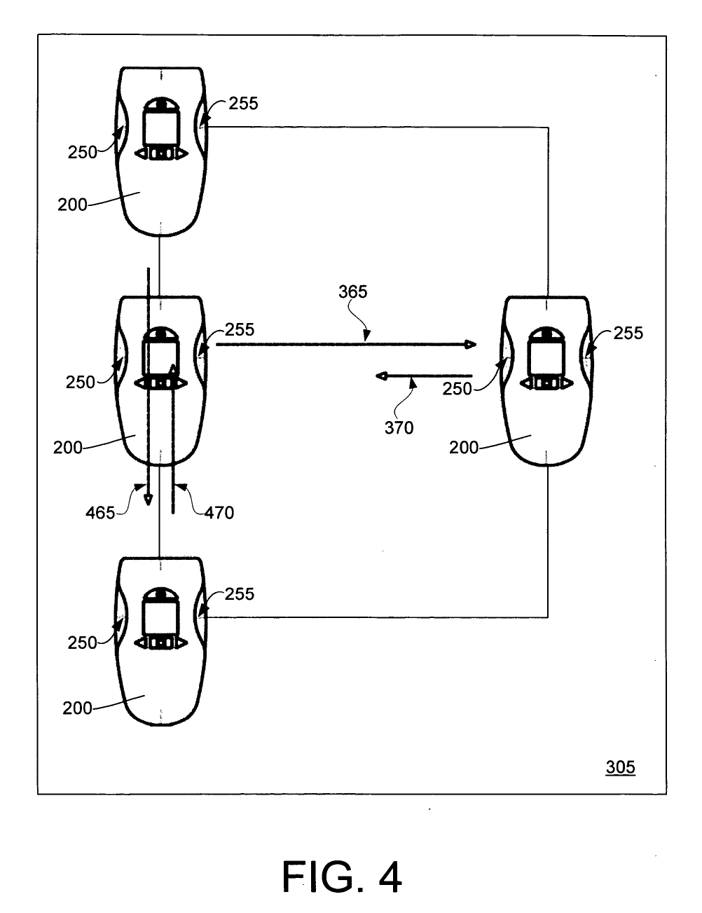

As shown in FIG. 4, the same method as described with reference to FIG. 3 may be employed to identify the location of the upper and lower edges of the printing area 305. Therefore, after the alignment marks are used to align the hand-held printer 200 with the left and right edges of the printing area 305, the user may be instructed, via the display, to drag the printer 465, 470 to an upper or lower edge of the printing area 305. The user may then align the edge with the left and/or right alignment marks 250, 255. Once again, using its at least one internal tracking device the printer 200 will identify and store the respective positions of the upper and lower edges of the printing area 305.

Based on the coordinates of the left, right, upper and lower edges, the printer 200 may identify the print area of the printing surface 305. According to an embodiment of the invention, the printer 200 may presume that the right and left edges form right angles with the upper and lower edges, which allows the printer 200 to identify the entire print area of the printing surface 305. For instance, in a coordinate system where the first number in a coordinate pair identifies the horizontal location of the printer 200 and the second number identifies the vertical location of the printer 200, if the left edge is set to coordinates 0,0, the right edge may be at X,Y due to horizontal (and possibly inadvertent) vertical displacement when the user drags the hand-held printer 200 across the printing area 365 to the opposing edge 308 of the printing area 305. Similarly, the location of the printer at a top edge of the area 305 may be coordinates A,B and the location of the printer at a bottom edge may be coordinates C,-D. In this illustrative example, the printer may presume that the top left corner of the printing area 305 is at coordinate 0,B, the top right corner is at coordinate X,B, the lower left corner is at coordinate 0,-D, and the lower right corner is at coordinate X,-D. Based on this information, the printer can determine the print area of the printing surface 305.

According to one aspect of the invention, the width and/or height of the printing area 305 may be displayed to the user on the display 230 as the user is executing the measuring of the area 305 via dragging the printer 200 across the printing area 305. Additionally, a graphical representation of the size of the printing area along with the image to be printed may be displayed to the user after the measurement is complete.

After the user has completed measuring the size of the printing area 305, the user may proceed with printing an image. Prior to printing the image, the printer utilizes the width and height of the printing area 305 to scale an image such that the image fits on the printing area 305. More particularly, the hand-held printer 200 is operable to scale an image up or down, stretch an image horizontally or vertically, or crop an image to fit on a printing area. To determine whether an image must be scaled to fit on the printing area 305, the hand-held printer will compare the size of the image to the available print area on the surface. As described below, this comparison may take into account margins or other user-input settings defining or restricting the allowable print area of the printing surface 305. These user inputs may be stored as settings in the hand-held printer, and may be used for the comparison process and to determine whether an image should be scaled and/or repositioned.

The comparison and scaling/repositioning determination may be effected by one or more algorithms stored within a memory of the hand-held printer 200, which may be executed by the aid of a processor or like computing device to effect the processes described herein. Alternatively, the hand-held printer 200 may include an application specific integrated circuit (ASIC) or the like to effect the processes described herein.

According to one aspect of the invention, the user may elect whether or not scaling to fit the printing area 305 is desired by configuring one or more settings that may be accessed and set using the one or more buttons. The user may also elect whether to maintain the correct proportions of an image, or whether the image is stretched horizontally or vertically. According to one aspect of the invention, the desired image size may be set by the user before measurement of the printing area begins. For instance, even before measurement, the user may specify the percentage of print area that should receive an image, and/or the location of the image on the printing area. Thus, in addition to scaling an image, a position of an image may be centered (horizontally or vertically) or left or right justified on a print area 305. Additionally, the user may select whether the image is proportionally scaled, or reduced in size in one orientation (e.g., widthwise). This may be useful, for instance, where an image fits within the width of a printing area, but not within the height of a printing area. Additional settings are also possible. For instance, the hand-held printer may be operable to include margins on a print area 305, such that the image is off-set on the surface and placed within user-specified margins. It will be appreciated that in addition to scaling an image down, a hand-held printer according to the present invention may increase the size of an image using one of the above methods to fit a printing area 305.

Once the settings are established, a user may begin printing an image. This may require the selection of a print mode on the hand-held printer 200, which may be automatically activated upon completion of identifying the fourth edge of a printing area. Alternatively, the measurement mode may be deactivated and the print mode may be activated automatically when the hand-held printer is aligned on the first edge used in the measurement step. Using the known, stored size of the printing area 305, the hand-held printer 200 will determine the image size or position on the surface 305 based on the pre-set image size and image position settings pre-selected by the user. To print the image the printer 200 is moved across the area 305. As the printer moves across the surface, the image is placed onto the media. Because the location of the printer and its direction of movement is known, based on the internal tracking device, the printer is operable to print the necessary elements image at each location in which the printer is moved.

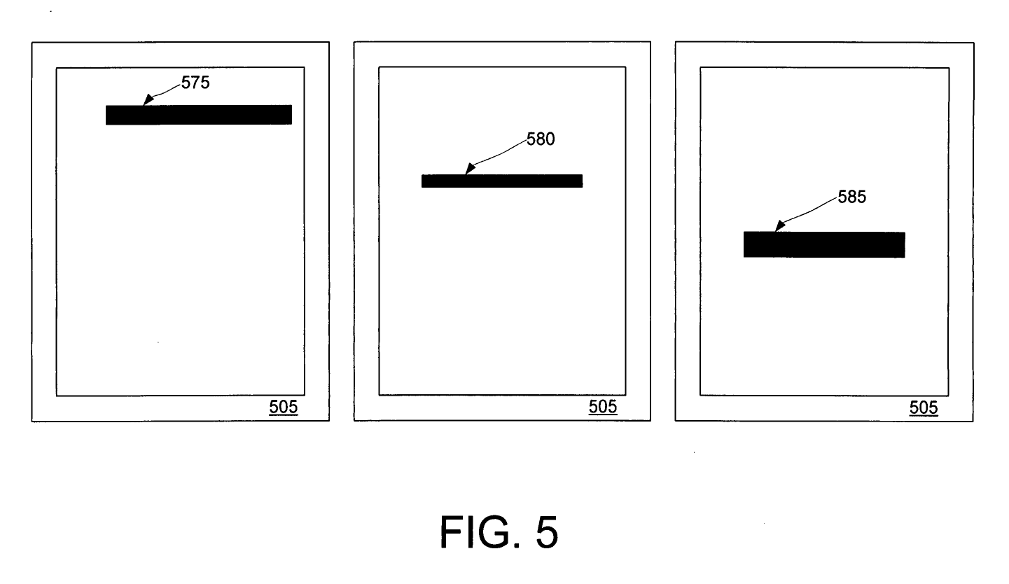

FIG. 5 shows a printing area 505 including an original image 575, and scaled and stretched versions of the original image 575, according to an illustrative example of the present invention. The scaled and stretched versions of the original image represent illustrative outputs of the printer 200 where the user has chosen to center the horizontal placement of the original image 575. For instance, after the user has configured one or more settings to effect centering the original image 575 and to scale it, the hand-held printer may print the scaled image 580. Alternatively, if the user has configured one or more settings to effect centering the original image 575 and to stretch it, rather than scale it, the hand-held printer may print the stretched image 585. The size of original image 575 was reduced vertically and horizontally by an equal percentage in the scaled image 580. The stretched image 585, on the other hand, illustrates a stretched version of the original image 575, where the original image 575 was reduced in size (stretched by a factor less than 100%) in only the horizontal direction, so that the vertical dimensions of the stretched 585 remain the same as the original image 575.

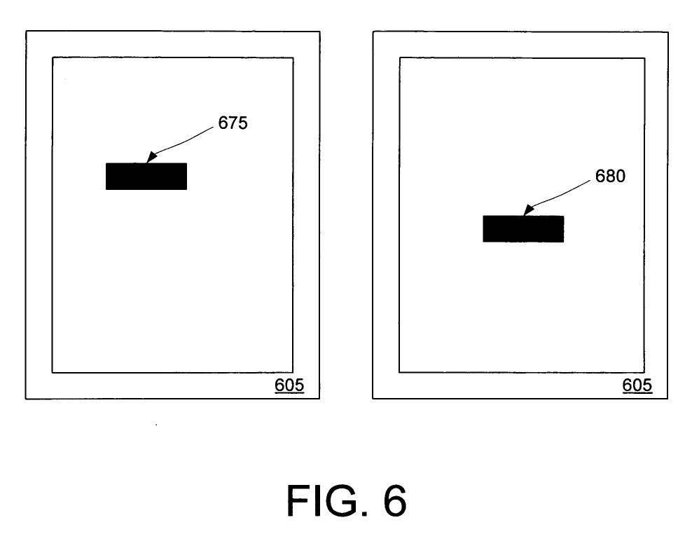

Although the illustrative example of FIG. 5 illustrates a centering function of the hand-held printer, hand-held printers according to the present invention may also place an image on a printing area based on the user's desired vertical position, such as centered on the page, offset by margins, offset by headers, footers, and the like. FIG. 6 shows a printing area 605 including an original image 675 and a repositioned version 680 of the same, according to an illustrative example of the present invention. For instance, the user may set one or more settings identifying a desired image position, for instance, both vertically and horizontally centered on a printing area 605. Therefore, based on the known size of the printing area 605, as determined based on the measurement mode, the hand-held printer 200 of the present invention may reposition the original image to the center of the printing area. This may require that the printer transpose image pixels by a horizontal and vertical distance.

It will be appreciated that the present invention may incorporate virtual any image processing techniques configurable by a user to effect the placement of an image on a page. Therefore, any combination of image scaling, stretching, cropping, repositioning, flipping, rotation, reversing, and the like may be implemented by the hand-held printer based on the measurement of a print area, as measured using the methods described above, in combination with user settings.

In addition, the printer may be used as a measuring device that could display the distance moved on the display screen, mark the page at predetermined incremental distances, or mark the page when instructed by the user, or a combination of these functions. For example, the printer could be used to place crop marks on a surface indicating the corners of an object (photograph) to be placed onto the surface in a predetermined specified location (e.g. centered on the page).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of printing an image using a hand-held printer, comprising:
identifying a first edge of a printing area;
identifying a second edge of the printing area, the second edge being substantially opposite the first edge;
determining a distance between the first edge and the second edge;
resizing an original image to create a resized image, wherein resizing the original image is based at least in part on the distance between the first edge and the second edge; and
printing the resized image using the hand-held printer.

2. The method of claim 1, further comprising comparing the distance between the first edge and the second edge against a dimension of the original image in creating a resized image.

3. The method of claim 1, wherein resizing the original image comprises scaling or stretching the original image.

4. The method of claim 1, further comprising receiving at least one user setting associated with the resizing of the original image.

5. The method of claim 4, wherein the at least one user setting identifies a desired position of the resized image on a printing surface.

6. The method of claim 5, wherein printing the resized image comprises printing the resized image on the printing surface at the desired position.

7. The method of claim 1, further comprising identifying a location of at least one margin associated with the printing surface, and wherein resizing the original image further comprises resizing the original image based at least in part on the location of the at least one margin.

8. The method of claim 1, wherein a degree of resizing of the original image is based at least in part on the distance between the first edge and the second edge.

9. The method of claim 1, further comprising identifying a third edge of a printing area, and a fourth edge of the printing area, wherein the fourth edge is substantially opposite the third edge.

10. The method of claim 9, further comprising determining a distance between the third edge and the fourth edge, and wherein resizing the original image is based at least in part on the distance between the third edge and the fourth edge.

11. A hand-held printer, comprising:
a housing;
an optical sensor system that tracks a location of said printer as said printer is manually moved across a printing surface;
a memory disposed in said housing that stores data representative of an image;
a printhead equipped with one or more nozzles capable of ejecting ink; and
a processor that receives said image data from said memory and said printer location from said optical sensor system and controls said ejection of ink via said one or more nozzles;
wherein said printer operates in a first mode in which said printer measures at least one dimension of said printing surface, and a second mode in which said printer prints said image.

12. The hand-held printer of claim 11, wherein said processor is configured such that when said printer is in said first mode, said optical sensor system and said processor operate together to calculate a first distance between a first point and a second point.

13. The hand-held printer of claim 12, wherein said processor and optical sensor system are further configured to calculate a second distance between a third point and a fourth point.

14. The hand-held printer of claim 13, wherein said processor is additionally configured to resize an image based on said first and second distances.

15. The hand-held printer of claim 13, wherein said processor is additionally configured to identify a target destination for a printed image.

16. The hand-held printer of claim 15, wherein said processor is configured to print said image at said target destination by controlling said one or more nozzles in response to a movement of said hand-held printer across said printing surface.
